(19) United States
(12) Patent Application Publication
(10) Pub. No.: US 2002/0011953 A1
(43) Pub. Date: Jan. 31, 2002

(54) WIDE BEAMWIDTH ANTENNA

(76) Inventors: JOHN K. REECE, COLORADO SPRINGS, CO (US); JOHN L. ADEN, COLORADO SPRINGS, CO (US)

Correspondence Address: LYON & LYON LLP, 633 WEST FIFTH STREET, SUITE 4700, LOS ANGELES, CA, 90071, US

(21) Appl. No.: 09/415,608

(22) Filed: Oct. 8, 1999

(51) Int. Cl. H01Q 1/42

(52) U.S. Cl. 343/700 MS; 343/789

(57) ABSTRACT

An antenna comprising a substrate and a folded radiating element. The folded radiating element and the substrate define a resonant cavity which produces a wide beamwidth, and substantially hemispherical radiation pattern. An antenna constructed in accordance with the present invention can be incorporated into a transceiver system. The radiation pattern produced by the antenna is suitable for use in wireless communication systems operating in the PCS and DCS frequency ranges.

### FIELD OF THE INVENTION

The present invention pertains to antenna systems, and more particularly, to patch antenna systems.

### BACKGROUND OF THE INVENTION

Wireless communication systems most often utilize a series of transceivers installed on a building wall, utility pole or other structure. In order to transmit and receive signals, these transceivers require an antenna. Commonly, the antennas are directly connected to the transceiver housing through a bulkhead connector. Antennas directly connected to a transceiver housing are typically small, omni-directional antennas. Alternately, stand alone antennas can be mounted at a remote location and are connected to a transceiver through an extended cable. The physical size of stand alone antennas generally reduces their applicability to small transceivers, particularly when the transceivers are intended to be mounted to the sides of buildings or on top of a utility pole. The aesthetic impact of such obtrusive antennas further detracts from their applicability in a residential or congested area where zoning regulations may prevent the use of larger structures.

Patch antennas, a type of microstrip structure, are another type of antenna used in transceivers. Patch antennas are partially formed from a thin sheet of low-loss insulating material, called a dielectric substrate. In addition to its electrical characteristics, the substrate often forms the structural base of the patch antenna. To complete the antenna structure, the dielectric substrate is covered with metal on one side, (the ground plane), and is partially metalized on the other side, where the patch antenna pattern is printed or otherwise formed. The substrate typically serves two purposes. First, it may act as a mechanical backbone by providing a stable support for the other antenna elements. Second, the substrate fulfills an electrical function by concentrating electromagnetic fields and preventing unwanted radiation in the associated circuits. The permittivity and thickness of the dielectric substrate affects the electrical characteristics of the antenna.

The coverage that an antenna achieves is determined in large part by the geometry of the radiating element or elements. A microstrip patch antenna in particular, may have a gain within the 5-6 dB range and exhibit a 3-dB beamwidth between 70° and 90° (See FIGS. 8 and 9 for these and other plane definitions). Applications which require wide beam patterns, such as mobile and personnel communication systems, usually benefit from a patch antenna arrangement utilizing a single radiating element. When a narrower beamwidth is required or a more directive antenna is needed, a number of identically radiating elements may be grouped together to form a periodic array providing a higher degree of directivity. The selection of a particular shape for the radiating element usually depends on the parameters one wishes to optimize. Rectangular patches are commonly used to realize microstrip patch antennas in wireless communication systems due to the wide beamwidth and large coverage area of the radiation pattern.

In general, antennas interact with objects that are placed close to them and must usually be mounted at a sufficient distance from walls or at the top of a tall mast or pole. But since microstrip patch antennas become somewhat shielded by the presence of the ground plane, whatever is placed behind them typically does not significantly affect their operation or the effective radiation pattern. Microstrip patch antennas can normally be mounted directly on the walls of buildings and, due to their relatively low profile and small size, become less conspicuous than other antennas. In the realm of personal wireless communication systems, this feature of microstrip patch antennas is an advantage when transceivers are placed in congested urban areas or in otherwise conspicuous locations.

The bandwidth of a microstrip patch antenna can also be increased by the use of parasitic elements (dipoles) next to or otherwise in close proximity to the main radiating element. Parasitic elements are excited through a capacitive coupling to the main radiating element.

Particularly in wireless communication systems, the integration of a patch antenna system into a transceiver enclosure is of particular importance. U.S. patent application Ser. No. 09/316,459 entitled “Radiating Enclosure”, and Ser. No. 09/316,457 entitled “Capacitive Signal Coupling Device”, both filed on May 21, 1999, describe preferred embodiments of such an integrated antenna system. The entirety of these disclosures are hereby incorporated into the present application by reference.

In the personal communications industry, the PCS (1850 MHz-1990 MHz) and the DCS (1710 MHz-1880 MHz) ranges, require an antenna system which is optimized for performance in these ranges. Thus, what is needed is an antenna system integrated into the transceiver housing while simultaneously meeting the performance requirements for coverage and impedance match, low gain and wide beamwidth hemispherical coverage in the PCS and DCS frequency ranges.

### SUMMARY OF THE INVENTION

The present invention allows for integration of an antenna in a transceiver housing while providing wide beamwidth and hemispherical coverage. An antenna constructed in accordance with the present invention comprises a substrate and a folded radiating element that defines a resonant cavity.

In a preferred embodiment, the folded radiating element includes a first component oriented at an angle to the substrate and a second component oriented substantially parallel to the plane of the substrate. The second component is spaced a distance from the substrate and the resonant cavity is defined by the substrate and the folded radiating element.

In a further preferred embodiment, a transceiver comprises an enclosure, transceiver circuitry and an antenna constructed in accordance with the present invention. The antenna produces a wide beamwidth and substantially hemispherical radiation pattern suitable for use in PCS and DCS wireless communication systems.

### BRIEF DESCRIPTION OF THE DRAWINGS

FIGS. 1A and 1B are perspective views of a wall or pole mounted transceiver (with the cover open) which incorporates a wide beamwidth folded patch antenna constructed in accordance with the present invention;

FIG. 2 is an exploded perspective view of a wide beamwidth folded patch antenna constructed in accordance with the present invention;

FIG. 3 is a top plan view of the antenna of FIG. 2;

FIG. 4 is a bottom plan view of the antenna of FIG. 2;

FIG. 5 is a cross sectional view of the antenna of FIG. 3, taken at section marks A-A;

FIG. 6 is an exploded perspective view of a folded patch antenna radiating element and its associated mounting flange;

FIGS. 7A and 7B are diagrammatic perspective views of the folded patch antenna element mounted to a substrate;

FIG. 8 is a diagram defining the H-plane and E-plane radiation patterns;

FIG. 9 is a diagram defining the polarized 45°+−45° planes in an antenna radiation pattern;

FIG. 10 shows a preferred embodiment of the substrate of a folded patch antenna constructed in accordance with the present invention;

FIGS. 11A & 11B show a preferred embodiment of the radiating antenna element of a folded patch antenna constructed in accordance with the present invention;

FIGS. 12A & 12B show a preferred embodiment of the parasitic disk of a folded patch antenna constructed in accordance with the present invention;

FIGS. 13A & 13B show a preferred embodiment of the dielectric cylinder of a folded patch antenna constructed in accordance with the present invention;

FIG. 14 is a graph of the E-plane, H-plane, and 3 Db radiation patterns of a wide beamwidth folded patch antenna integrated into a transceiver at a frequency of 1850 MHz.

FIG. 15 is a graph of the E-plane, H-plane, and 3 Db radiation patterns of a wide beamwidth folded patch antenna integrated into a transceiver at a frequency of 1920 MHz.

FIG. 16 is a graph of the E-plane, H-plane, and 3 Db radiation patterns of a wide beamwidth folded patch antenna integrated into a transceiver at a frequency of 2000 MHz.

FIG. 17 is a graph of the −45° plane, +45° plane, and 3 Db radiation patterns of a wide beamwidth folded patch antenna integrated into a transceiver at a frequency of 1850 MHz.

FIG. 18 is a graph of the −45° plane, +45° plane, and 3 Db radiation patterns of a wide beamwidth folded patch antenna integrated into a transceiver at a frequency of 1920 MHz.

FIG. 19 is a graph of the −45° plane, +45° plane, and 3 Db radiation patterns of a wide beamwidth folded patch antenna integrated into a transceiver at a frequency of 2000 MHz.

### DETAILED DESCRIPTION OF THE PREFERRED EMBODIMENTS

Structure of the Patch Antenna

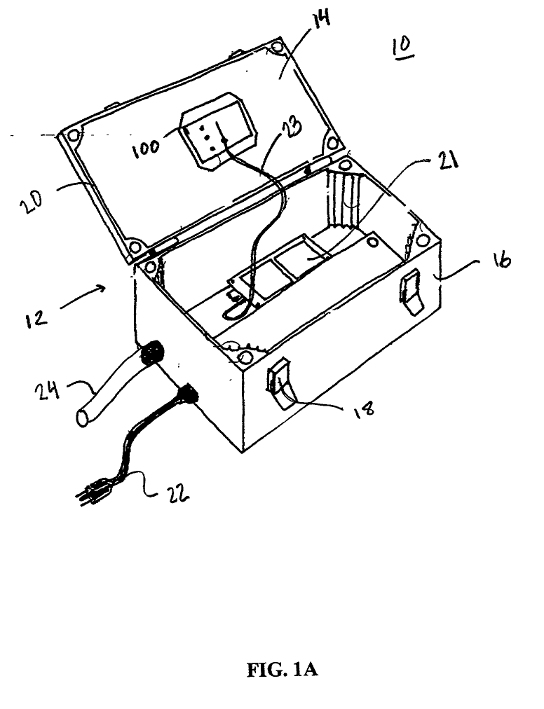

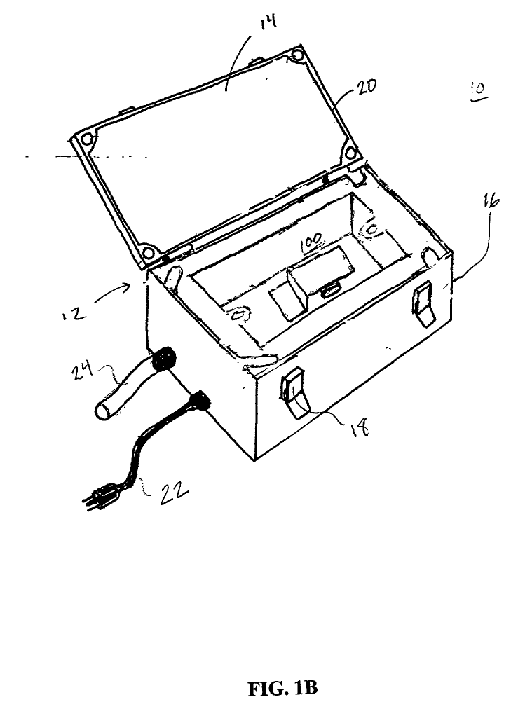

FIG. 1A shows a transceiver 10. The transceiver 10 includes a housing 12. Preferably, the housing 12 is formed from a cover 14 and a container 16. The cover 14 is preferably hinged to the container 16 for quick and simple access to the contents of the container 16. In FIG. 1, the housing 12 is shown with the cover 14 opened in order to illustrate several of the various components mounted within the transceiver 10. The cover 14 can also be attached by clamps 18 or a similar fastening device that would ensure that the components mounted within the transceiver 10 are not exposed to adverse environmental conditions such as moisture, dirt or oil. A gasket seal 20 may also be incorporated into the cover 14 or the container 16 in order to further ensure that the cover 14 forms a tight seal with the container 16 and that the components within the transceiver 10 are adequately protected.

The transceiver 10 is a self contained unit designed to provide a wireless link between a ground based communication device, such as a phone or a computer network, and a base station (not shown) such as a GSM base station. The transceiver 10 includes circuitry 21 as well as an antenna system 100. The antenna system 100 is attached to the cover 14 and is connected to the circuitry 21 via a cable 23. Preferably, the transceiver 10 is mounted to the side of a building or on top of a tall pole in close proximity to the area it provides service to.

The transceiver 10 is connected to an external power supply via a power cable 22. Data is transferred to and from the transceiver 10 via an appropriate data cable 24. Preferably, the data cable 24 is a coaxial cable.

FIG. 1B shows the transceiver 10 with the antenna system 100 incorporated into the container 16, rather than in the cover 14.

In operation, the transceiver 10 acts like a wireless phone or pager. Upon activation, the transceiver 10 establishes a link to a base station. The base station in turn routes the signal through either a land line based system or a satellite based system to a local public switched telephone network (PSTN) or another data distribution network. From the PSTN the signal is routed to the intended recipient. The intended recipient can be either a land line based customer or another wireless customer. The transceiver 10 provides a wireless link from a network or private phone line to the PSTN and eliminates the need for a lengthy network of land lines to connect many individual customers to the PSTN. Alternately, the transceiver 10 is itself a base station and communicates directly with a PSTN.

When installed, the transceiver 10 is hard wired into a home or business via the cable 24 and the power cable 22. Alternately, the transceiver 10 can receive power from an independent battery pack or other rechargeable power supply mounted in close proximity to the transceiver 10 or incorporated into the transceiver itself. The transceiver 10 is also preferably formatted to include features such as remote meter reading and programming capabilities. The details of such a programmable transceiver can be found in Lyon & Lyon docket No. 243/150, entitled “Data Terminal Apparatus”, the entirety of which is incorporated by reference into this disclosure.

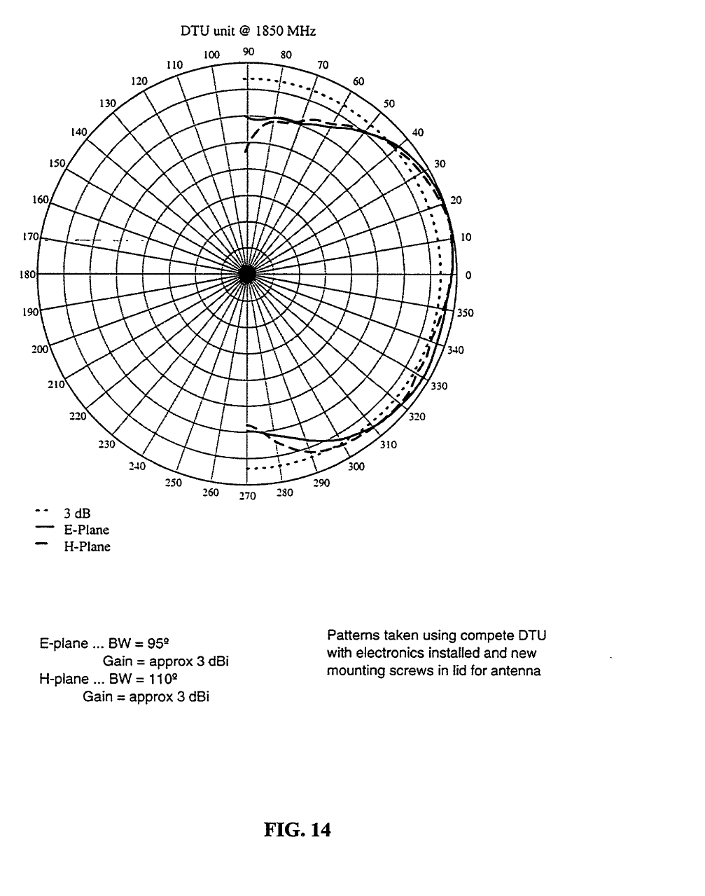

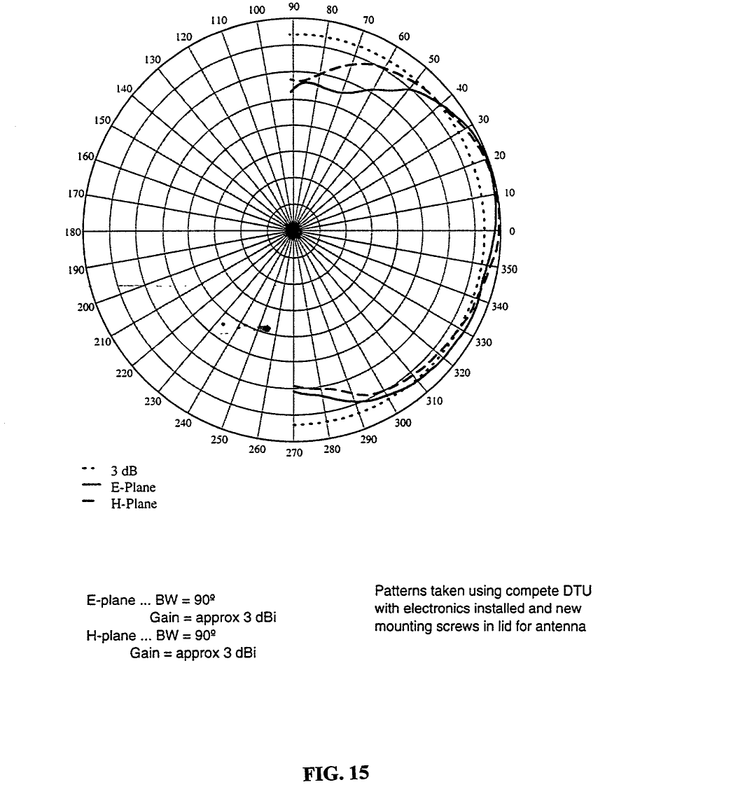

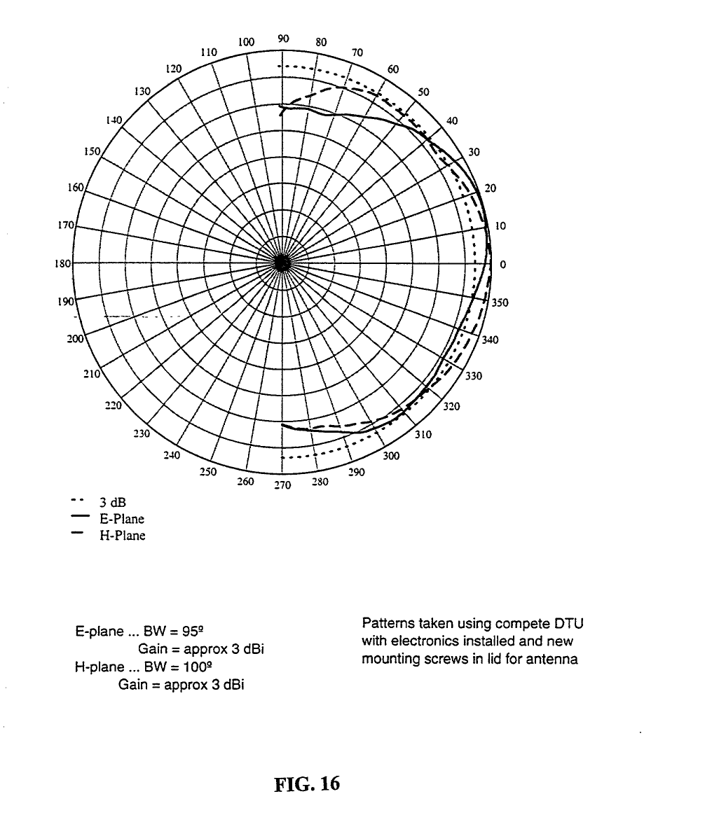

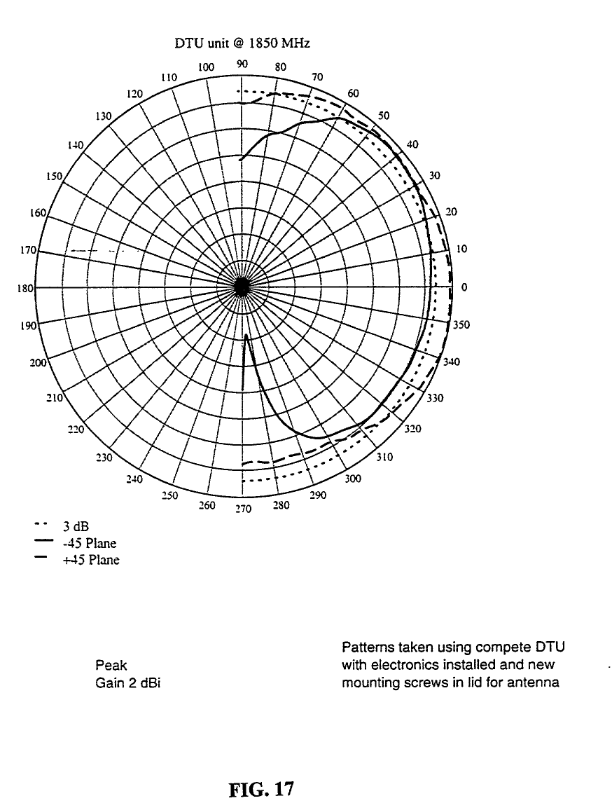

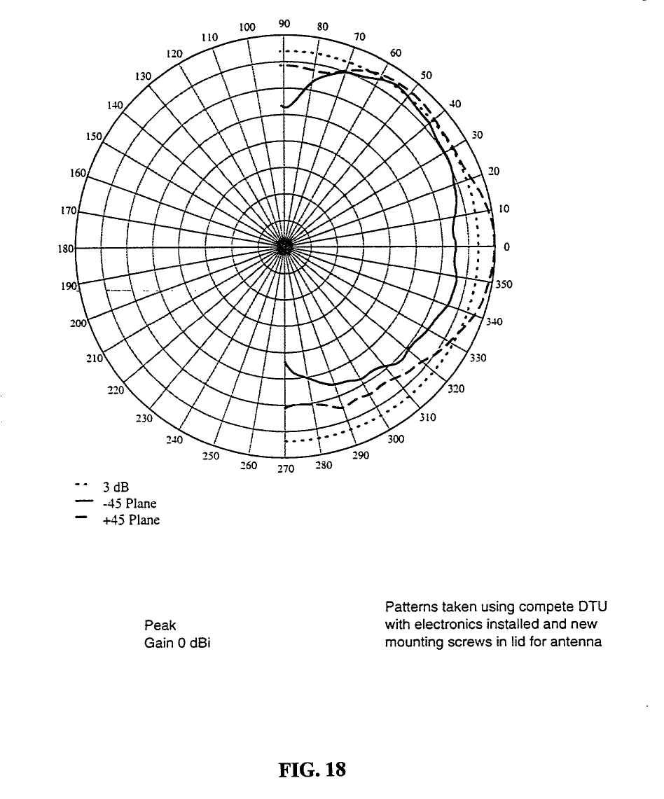

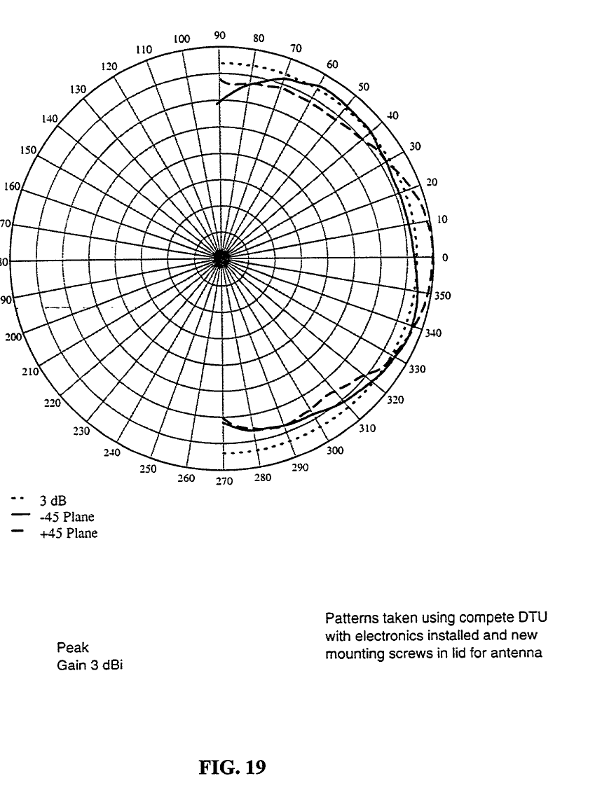

In order to complete the functionality of the transceiver 10, an antenna 100 is incorporated into its structure. Since the transceiver 10 is preferably mounted on a wall or pole, certain characteristics of the antenna 100 must be maintained in order to allow efficient communication with the base station or network which it communicates with. In particular, the radiation pattern produced by the antenna system must be formatted to transmit and receive information efficiently while taking into account the location where the transceiver may be mounted, as well as the design of the transceiver itself. Most notably, when mounted against a large flat surface, the transceiver antenna must provide a hemispherical radiation pattern which maximizes radiation in the directions away from the mounting surface. Similarly, the antenna design should minimize the radiation directed toward the mounting surface. FIGS. 14-19 illustrate the radiation patterns associated with a preferred embodiment of a wide beamwidth folded patch antenna system constructed in accordance with the present invention.

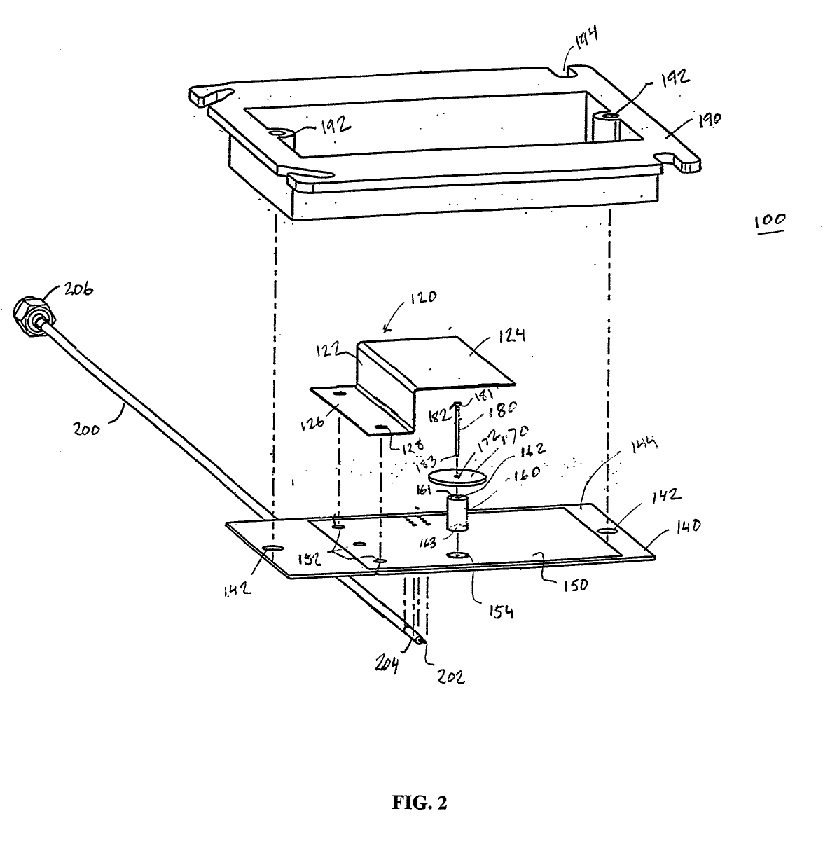

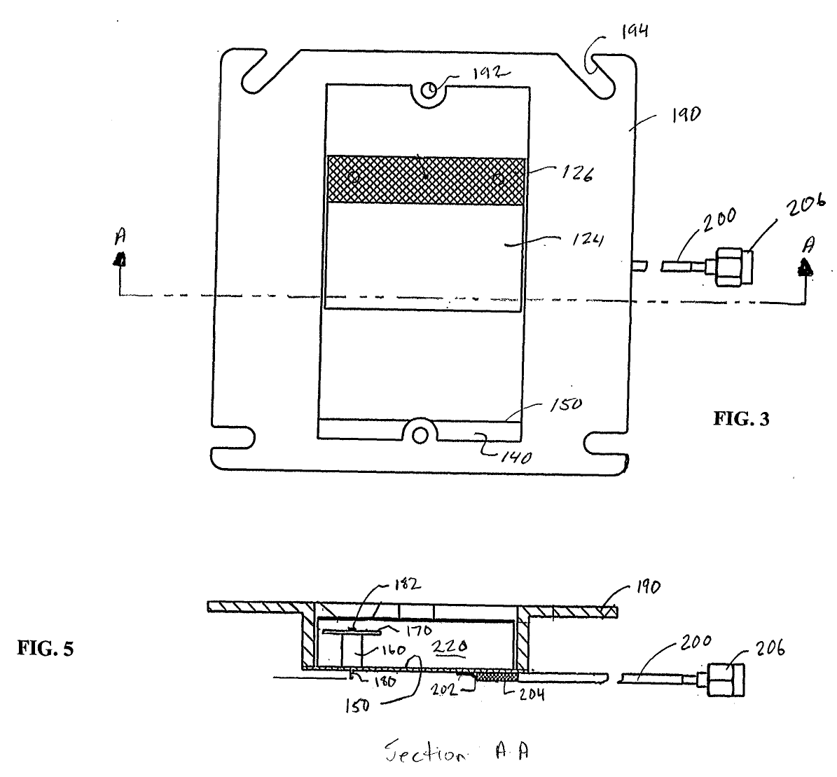

FIGS. 2-5 show a wide beamwidth folded patch antenna 100 constructed in accordance with the present invention. An antenna element 120 is formed into a folded shape. The radiating portion of the antenna element 120 is substantially L shaped and includes a first radiating component 122 and a second radiating component 124. Preferably, the antenna element 120 also includes a mounting flange 126 attached to a distal edge of the first radiating component 122. The mounting flange 126 allows the entire antenna element 120 to be connected to another surface. The two radiating components 122 and 124, along with the mounting flange 126 together form a folded or “step” shaped element. The mounting flange 126 is for electrically grounding the radiating components 122 and 124 to a ground plane 150 and for mechanically attaching and aligning the radiating components 122 and 124 to a substrate 140. The mounting flange 126 includes at least one aperture 128, but two or more apertures 128 are preferred in order to more effectively align the radiating element 120 prior to connecting it to the groundplane 150. Each of the apertures 128 are adapted to receive screws, rivets, bolts, or another type of suitable fastening device. In addition to using the apertures 128 to attach the antenna element to the ground plane, the mounting flange is also preferably soldered to the groundplane in order to ensure that a consistent electrical ground is maintained.

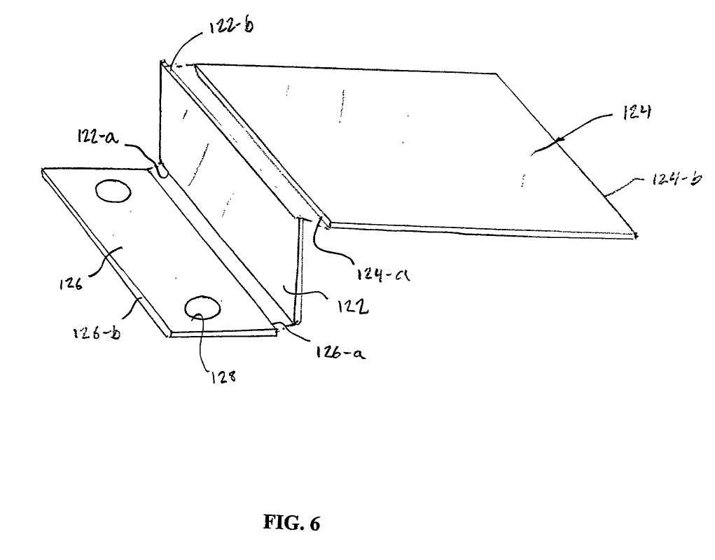

FIG. 6 illustrates in more detail, the construction and orientation of the antenna components, including the first radiating component 122, the second radiating component 124, and the mounting flange 126. The first radiating component 122 is preferably a thin rectangular element formed from a metallic material such as copper, silver, gold, or another material which is conducive to antenna applications. The first radiating component 122 has a first lengthwise edge 122-a and a second lengthwise edge 122-b, consistent with the geometry of a rectangle. The first radiating component 122 is positioned so that the first lengthwise edge 122-a is in contact with or otherwise attached to a first lengthwise edge 126-a of the mounting flange 126. When attached to the mounting flange 126, the first radiating component 122 projects away from and is substantially perpendicular to the mounting flange 126.

The second radiating component 124 is also preferably a thin rectangular element formed from a metallic material such as copper, silver, gold, or another material which is conducive to antenna applications. The second radiating component 124 has a first lengthwise edge 124-a and a second lengthwise edge 124-b, consistent with the geometry of a rectangle. The second radiating component 124 is positioned so that the first lengthwise edge 124-a is in contact with or otherwise attached to the second lengthwise edge 122-b of the first radiating component 122. When attached to the first radiating component 122, the second radiating component 124 projects away from and is substantially perpendicular to the first radiating component 122. The second radiating component 124 is spaced from and is substantially parallel to the substrate 140.

The entire antenna element 120, including the first radiating component 122, the second radiating component 124, and the mounting flange 126, thereby forms a step shaped element where the step has two “landings”, represented by the mounting flange 126 and the second radiating component 124, connected by a single “riser”, represented by the first radiating component 122. When taken individually, the radiating components 122 and 124 form a substantially “L” shaped element.

Preferably, the step-shaped antenna element 120 is a unitary piece formed from a single piece of material. Mechanically joining the mounting flange 126, the first radiating component 122 and the second radiating component 124 is therefore unnecessary during manufacturing. If formed separately, each of the antenna elements are preferably welded or soldered together so that a uniform and consistent connection is maintained.

Referring again to FIG. 2, the substrate 140 forms the structural base of the wide beamwidth folded patch antenna 100. The substrate 140 plays a dual role. Electrically it is part of the transmission lines, circuits, and antenna. Mechanically, it supports the structure of the antenna. The construction of the substrate must therefore satisfy both electrical and mechanical requirements. The relevant electrical properties of the substrate are the relative permittivity εᵣ, the substrate thickness h, and the dielectric loss factor tan δ. In antenna applications, it is important to keep a constant permittivity across the substrate, as well as a uniform thickness. The dielectric losses of the substrate must be as small as possible in order to ensure a high circuit performance and a good overall efficiency. Typically tan δ should be smaller than 0.002.

Physically, the substrate must have a large enough mechanical resistance, a good shape stability, and an expansion factor close to that of the metal used for the conductors and ground plane. It should withstand high temperatures during soldering and present a smooth and flat surface to reduce losses. Many materials are commercially available for forming such substrates including alumina (Al₂O₃), beryllia (BeO), teflon, polypropylene, silicon, and ferrite.

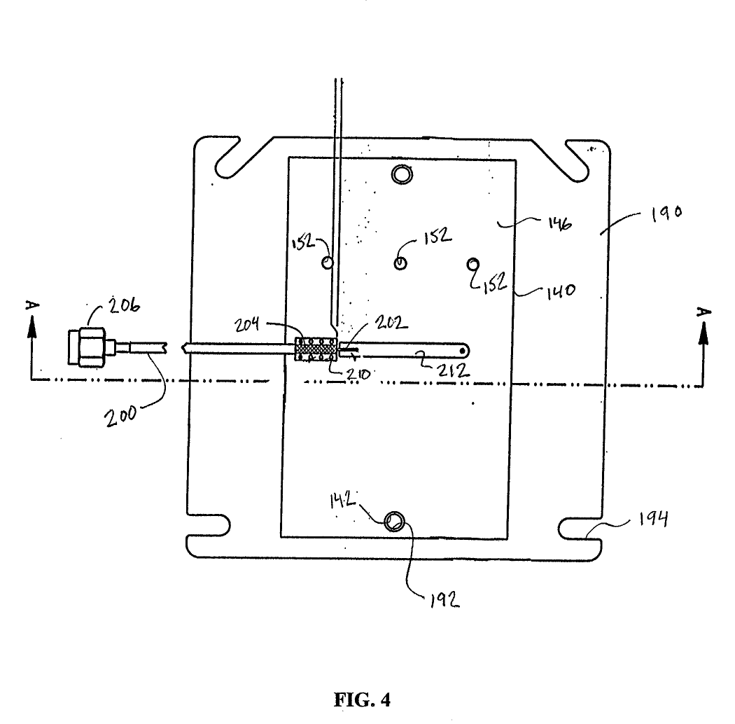

The substrate 140 has an first surface 144 (See FIG. 2)and a second surface 146 (See FIG. 4). A portion of the first substrate surface 144 is coated with the metalized ground plane layer 150. Apertures 152 extend through both the ground plane layer 150 and the substrate 140. The apertures 152 are adapted to receive a fastening device such as a screw, rivet or bolt. When positioned on the first surface 144 of the substrate 140, the apertures 128 of the mounting flange 126 align with the apertures 152, allowing the elements to be aligned and securely connected together with a mechanical fastening device. The elements can also be soldered together. The substrate 140 also includes additional apertures 142 which are similarly adapted to receive a fastening device. The apertures 142 allow a standoff 190 (described below) to be secured to the substrate 140.

The metal ground plane layer deposited on the substrate must have a very low resistivity (small ohmic losses), a sufficient thickness, a good solderability, and a good adhesion to the substrate 140. The metalized material must be resistant to oxidation during soldering processes and suitable for different contact making and bonding techniques. These requirements typically limit the choice of the metal to copper, silver, gold, and maybe aluminum. Certain other synthetic materials are also commercially available.

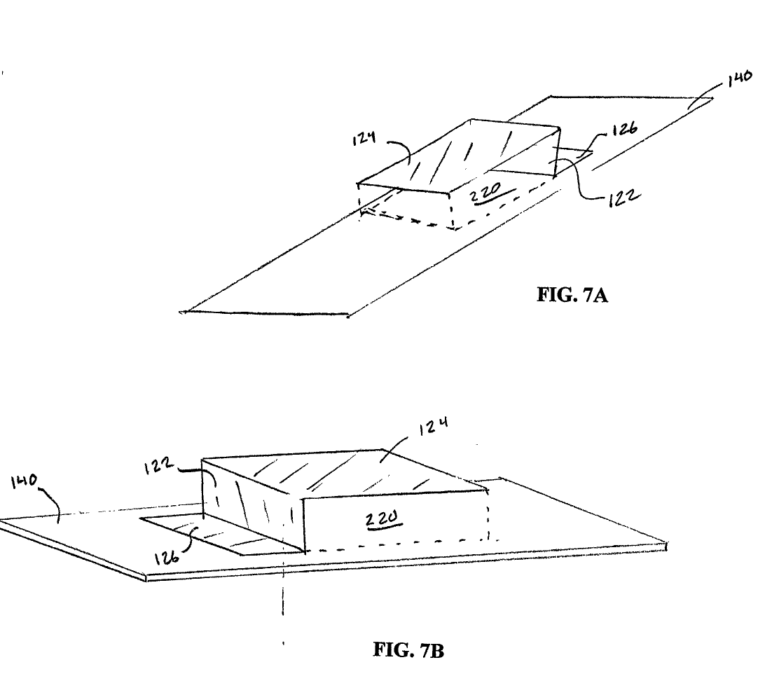

With the antenna element 120 mounted to the substrate 140, a resonant cavity 220 is defined. More particularly, the resonant cavity 220 is the volume of space bordered by the second radiating component 124 on one side, bordered by the first radiating component 122 on a second side, and bordered by the substrate 140 or ground plane 150 on a third side. The remaining three sides of the resonant cavity 220 are open ended and do not have a solid surface defining their boundaries. The resonant cavity 220 is the volume of space within this region. FIGS. 7A and 7B further define the resonant cavity 220, the open ended borders of which are represented by dashed lines. In operation, the maximum radiation occurs at the open end which is opposite to the first radiating component 122. Secondary radiation occurs from the other two open sides.

Referring again to FIGS. 2-5 and located within the resonant cavity 220, several additional antenna elements are present. These include a dielectric cylinder 160, a parasitic element 170 and a pin 180. The dielectric cylinder 160 includes a first dielectric surface 163, a second dielectric surface 161, and a passage 162 through its longitudinal axis. The dielectric cylinder 160 is positioned so that the passage 162 is aligned with an aperture 154 which extends through both the ground plane 150 and the substrate 140. The parasitic element 170 is preferably wafer shaped, similar to that of a thin disk, and is positioned on the second dielectric surface 161. The parasitic element 170 includes an aperture 172 extending through its longitudinal axis. When the parasitic element 170 is centrally mounted on the second dielectric surface 161, the aperture 172 aligns with the cylinder passage 162 as well as the aperture 154. The pin 180 extends though each of the parasitic disk aperture 172, the dielectric cylinder passage 162 and the aperture 154. On a first end 181 of the pin 180 is a thickening or ridge 182. When the pin 180 is inserted through the passage 162, aperture 172 and aperture 154, the ridge 182 prevents the pin 180 from moving any further through the openings. The pin 180 therefore holds both of the dielectric cylinder 160 and the parasitic disk 170 attached to the substrate 140. A second end 183 of the pin 180 is then soldered or otherwise secured or bonded to the substrate 140. The parasitic element 170 and the dielectric cylinder 160 are thus permanently fixed to the substrate 140. The pin 180 serves as a signal feed and connects the antenna elements to a microstrip transmission line 212 located on the second substrate surface 146.

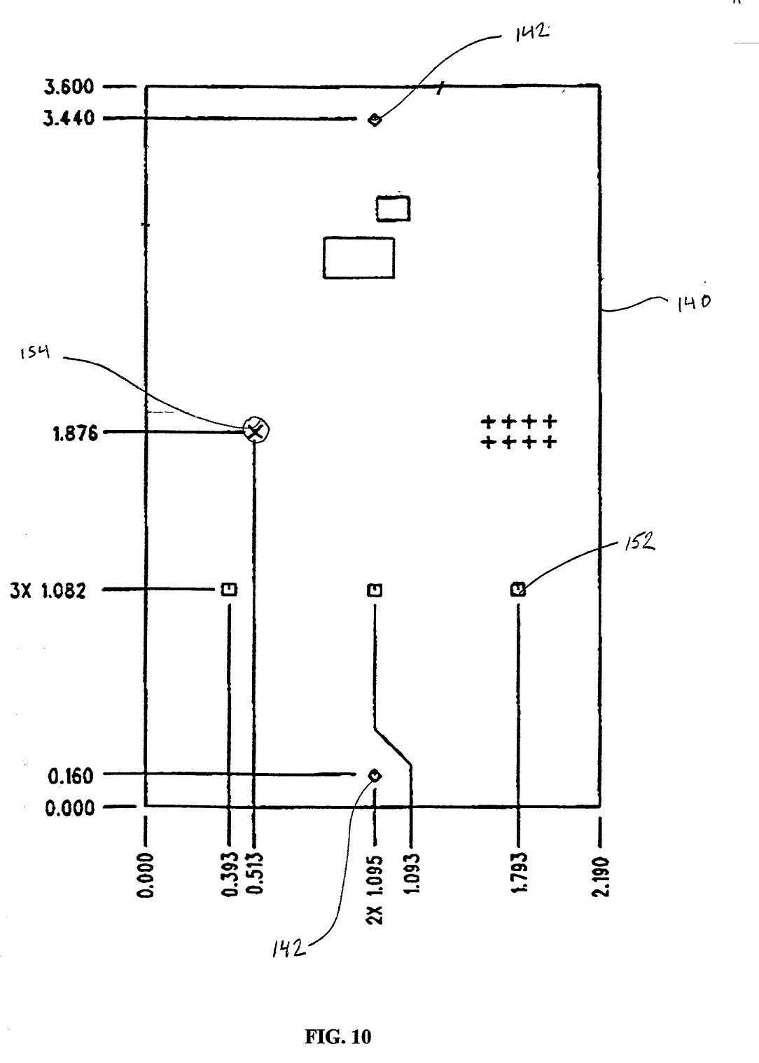

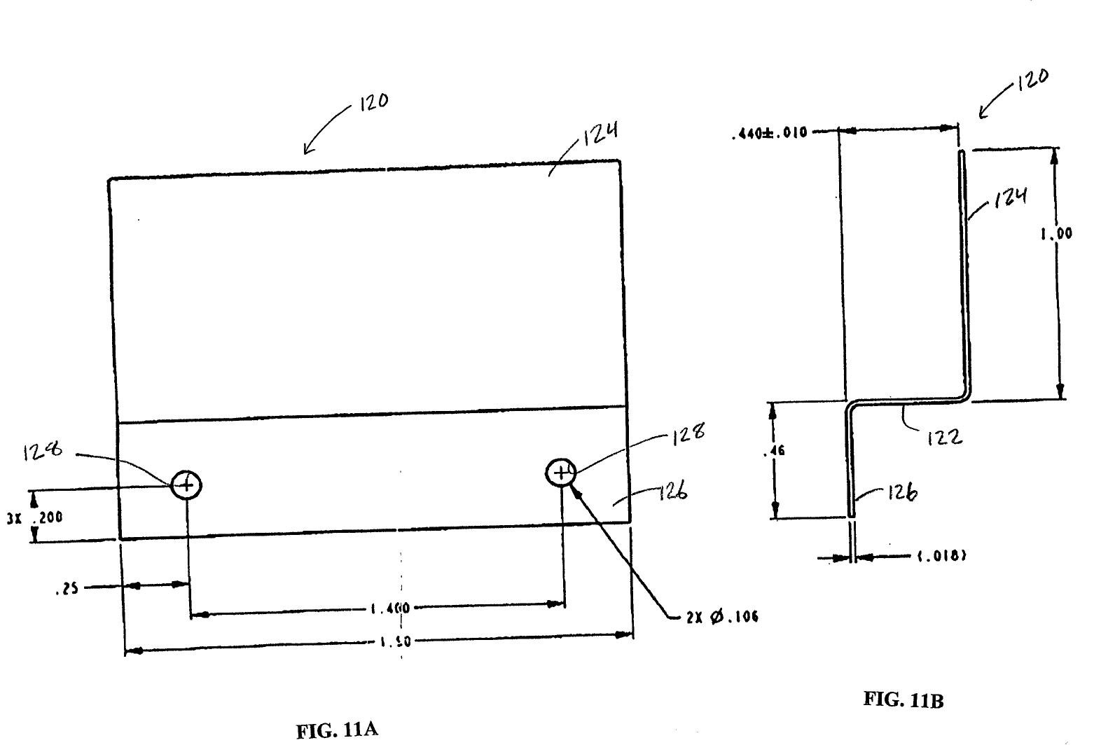

The location and dimensions of the dielectric cylinder 160, parasitic disk 170 and pin 180, in relation to the antenna element 120 are critical factors in the performance characteristics of the folded patch antenna 100. A preferred embodiment of the folded patch antenna elements is shown in FIGS. 10-13. All dimensions in FIGS. 10-13 are in inches.

A coaxial cable 200 provides a connection between the antenna elements and the transceiver circuitry mounted inside the housing 12. A copper pad 210 and the microstrip transmission line 212 are located on the second substrate surface 146. (See FIG. 4). The copper pad 210 and the microstrip transmission line 212 provide electrical connection and mechanical transition from the antenna elements to the coaxial cable 200. More particularly, copper pad 210 and microstrip transmission line 212 provide a smooth transition from the larger leads of the coaxial cable 200 to the microstrip elements of the circuitry and the patch antenna.

The coaxial cable 200 preferably includes a center conductor 202 and an outer jacket 204. The outer jacket 204 is soldered to the copper pad 210 which is in turn grounded to the ground plane 150. The center conductor 202 is soldered to the microstrip transmission line 212. On the free end of the coaxial cable, a fitting 206 is provided. The fitting 206 is preferably connected to its mate on the radio transceiver circuit board also mounted within the transceiver housing 12 (See FIG. 1A).

A standoff support structure 190 provides a partial enclosure as well as a mounting mechanism for the antenna. The standoff 190 includes apertures 192 which align with the apertures 142 on the substrate 140. The apertures 192 are adapted to receive a fastening device such as a screw, rivet or bolt. The standoff 192 can therefore be firmly secured to the substrate 140. Additionally, the standoff 190 includes recesses 194 which allow the standoff and antenna structure to be mounted within the transceiver housing 12 or to the lid 14. (See FIGS. 1A and 1B).

Radiation Patterns of the Present Invention

Antenna transmission properties are measured according to the radiation patterns generated by the radiating elements. The radiation pattern defines the spatial distribution of the power radiated by the antenna and is normalized with respect to its maximum value. The distribution of the electromagnetic fields in the vicinity of an antenna results from the multiple contributions of the waves excited by the antenna. This distribution can become quite complex, including both radiated waves and local concentrations of the electric and magnetic fields, which give rise to reactive effects. Therefore in the context of the present invention, the combined effects of the transceiver housing 12, the circuitry within the transceiver 10 and all of the other mechanical and electrical components, each contribute to the overall radiation pattern of the patch antenna. In particular, the size and shape of each of the antenna elements, the spacing between the second radiating component 124 and the ground plane 150, the spacing between the second radiating component 124 and the cover 14, and the feed point location, are all critical parameters that need to be customized for each specific application. The size of each of the radiating components 122 and 124, the ground plane 150, and the parasitic element 170 are also critical to the specific performance characteristics of the folded patch antenna.

The gain of an antenna, in a given direction, is defined by the ratio of the power radiated by the antenna to that radiated by a hypothetical lossless omni-directional antenna (called an isotropic radiator), which is fed with the same input signal. To determine the gain, one measures the power fed to the transmitting antenna and the power collected by the receiving antenna and then uses the Friis transmission formula:

Pᵣ=PᵢₙGₜGᵣ(λ/4πR)²

where Pᵣ is the received power, Pᵢₙ is the power fed to the input of the transmitting antenna, Gₜ is the gain of the transmitting antenna, Gᵣ the gain of the receiving antenna, λ is the free-space wavelength, and R is the distance between the two antennas. The ratio Pᵣ/Pᵢₙ is measured, and since λ and R are known, the product GₜGᵣ can be deduced. Three different possibilities can then be considered:

(1) One may already know the gain of the source antenna, either from previous measurements or because the antenna is a high-accuracy antenna that was originally calibrated in a standards laboratory.

(2) The two antennas used for the measurement are identical, in which case one has Gₜ=Gᵣ and takes the square root of the product.

(3) One has three antennas with unknown gains. The transmission between two of them is measured successively for the three different couples of antennas. The determination of the gains of the three antennas is then straightforward.

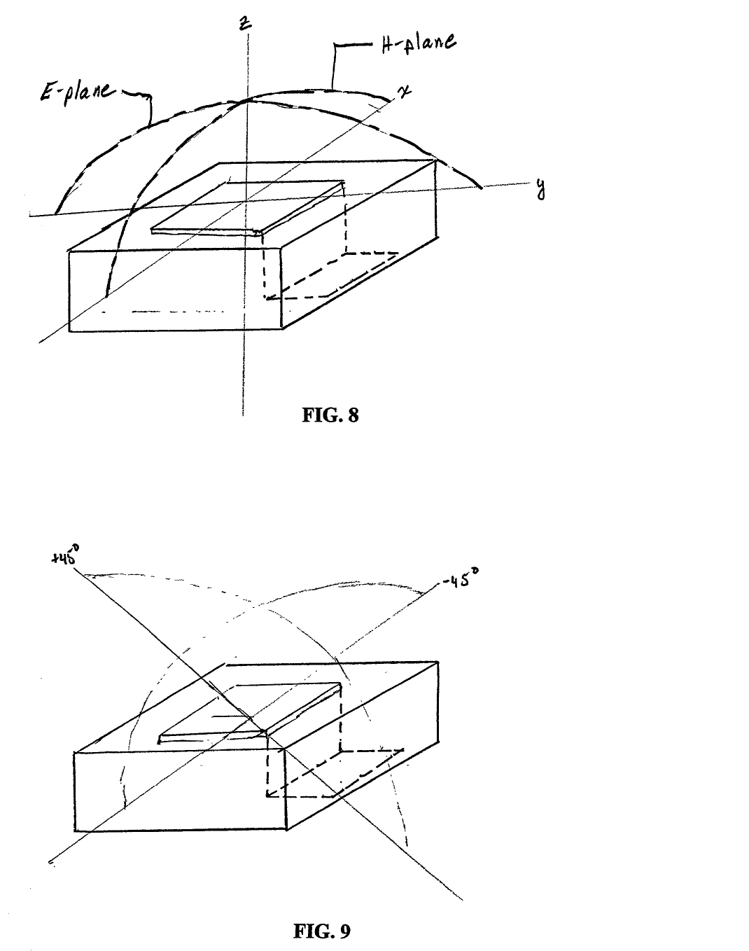

The radiation patterns of antennas, particularly patch antennas, are typically measured along a vertical plane (E-plane), along a horizontal plane (H-plane) and along a polarized plane defined as an angle from the vertical (−45°, +45°, etc.). FIGS. 8 and 9 illustrate the definitions of these planes in relation to a folded patch antenna constructed in accordance with the present invention.

As described above, the presence of microelectronics, rigid enclosures, fasteners, solder material and other hardware in the transceiver, each affect the radiation pattern and performance of the antenna. A preferred embodiment of a wide beamwidth folded patch antenna constructed in accordance with the present invention with dimension as described in FIGS. 10-13, achieves the necessary performance requirements for operation in the 1850 MHz-1990 MHz PCS band as well as the 1710 MHz-1880 MHz DCS band. Namely, the coverage and impedance match requirements are met even in the presence of the transceiver and micro-circuitry environment. Additionally, the antenna achieves low gain (4 Db), wide beamwidth hemispherical coverage, and minimal polarization discrimination in the above frequency bands.

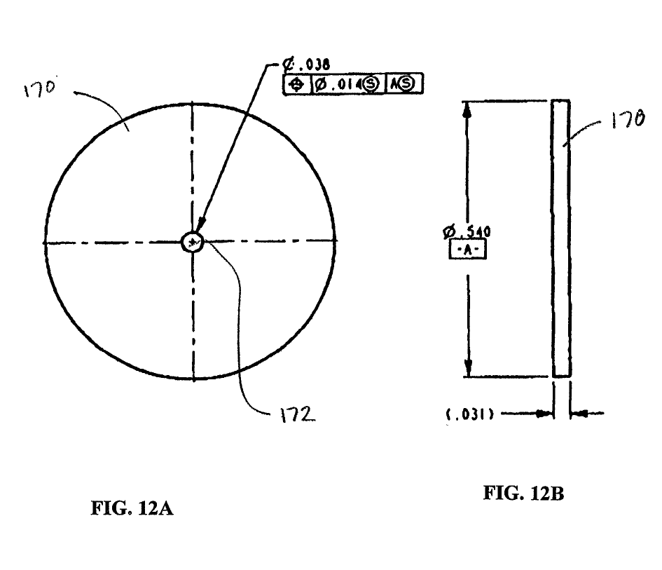

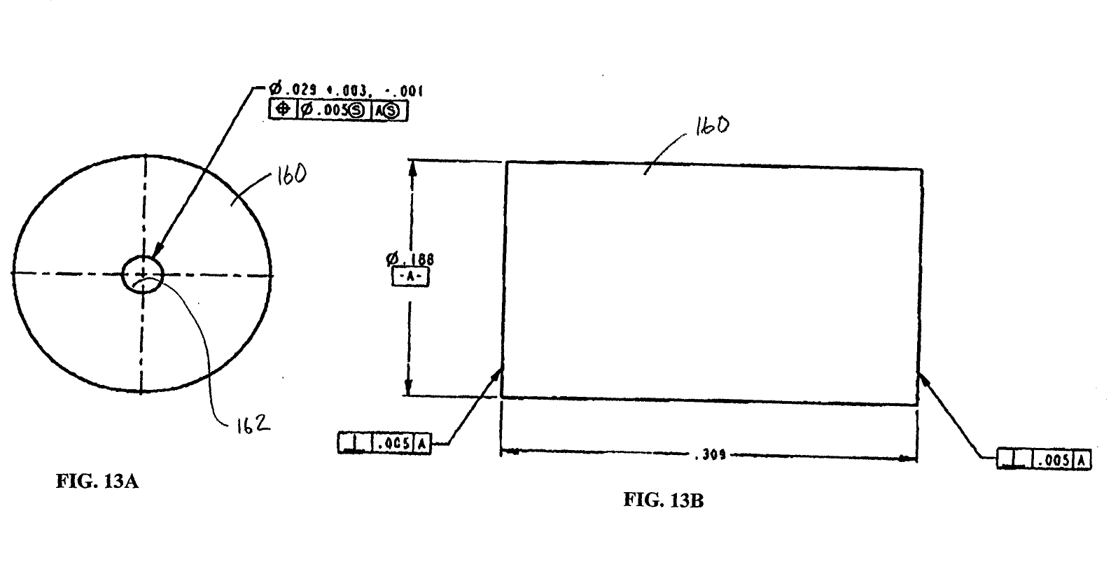

FIGS. 10-13 show the dimensional details of a printed circuit board (FIG. 10), a folded antenna element (FIGS. 11A and 11B), a parasitic element (FIGS. 12A and 12B), and a cylindrical dielectric element (FIGS. 13A and 13B), in a preferred embodiment, and for use as a PCS transceiver antenna system. The several components of a folded patch antenna constructed in accordance with the present invention were optimized to the dimensions in FIGS. 10-13. All dimensions are shown in inches.

Referring to FIG. 10 the substrate 140 has a length of approximately 3.6 inches and a width of approximately 2.19 inches. Apertures 154, 152, and 142 are also shown in FIG. 10, and particularly their relative locations on the substrate 140.

Referring to FIGS. 11A and 11B, the preferred dimensions of the antenna element 120 are shown. Apertures 128 are positioned so that they will align with the apertures 152 on the substrate 150.

Referring to FIGS. 12A and 12B, the preferred dimensions of the parasitic element 170 are shown. The parasitic element 170 is preferably a disk shaped element with a diameter of approximately 0.54 inches, a thickness of approximately 0.031 inches and a central aperture 172 with a diameter of approximately 0.038 inches.

Referring to FIGS. 13A and 13B, the preferred dimensions of the dielectric cylinder 160 are shown. The cylinder 160 preferably has a height of approximately 0.309 inches, a diameter of approximately 0.188 inches. The central passage 162 has a diameter of approximately 0.029 inches.

FIGS. 14-19 show the radiation patterns for an assembled transceiver 10 with all of the electronics installed and all mechanical hardware in place, including mounting screws and transmission cables. The radiation patterns shown in FIGS. 14-19 correspond to a folded patch antenna system built to the dimensions described in FIGS. 10-13. The radiation patterns are shown for the E-plane, H-plane, −45° polarization and +45° polarization at frequencies of 1850, 1920 and 2000 MHz. In each of the radiation patterns a substantially hemispherical pattern is produced, with little amplitude reduction at the extremities of the antenna elements (i.e. approaching 90° and approaching 270°). This radiation pattern provides the wide beamwidth hemispherical coverage pattern required in transceivers used for PCS and DCS communication systems.

Although the invention has been described and illustrated in the above description and drawings, it is understood that this description is by example only and that different embodiments may be made without departing from the true spirit and scope of the invention. The invention therefore should not be restricted, except within the spirit and scope of the following claims.

What is claimed is:

1. An antenna comprising:
a substantially planar substrate; and
a folded radiating element, said folded radiating element comprising a first component oriented at an angle to said substrate, and a second component oriented substantially parallel to the plane of said substrate, said second component spaced a distance from said substrate, said substrate and said folded radiating element defining a resonant cavity.

2. The antenna of claim 1, wherein said folded radiating element is substantially L shaped.

3. The antenna of claim 1, wherein said first component is oriented substantially perpendicular to said substrate and comprises a first lengthwise edge connected to said substrate and a second lengthwise edge, said second component is connected to said second lengthwise edge of said first component and is oriented substantially perpendicular to said first component.

4. The antenna of claim 1, wherein said substrate has a first substrate surface and a second substrate surface, and wherein a ground plane is formed on said first substrate surface.

5. The antenna of claim 4, further comprising a dielectric member, said dielectric member has a first dielectric surface in contact with said ground plane and a second dielectric surface.

6. The antenna of claim 5, further comprising a parasitic element attached to said second dielectric surface, wherein said dielectric member and said parasitic element are positioned within said resonant cavity.

7. The antenna of claim 1, wherein said defined resonant cavity produces a wide beamwidth, polarization diverse, and substantially hemispherical radiation pattern.

8. The antenna of claim 6, wherein said parasitic element is disk shaped.

9. The antenna of claim 1, wherein said substrate is formed from a dielectric material.

10. The antenna of claim 4, further comprising microstrip circuitry formed on said second substrate surface.

11. The antenna of claim 10, wherein said microstrip circuitry is printed on one of said substrate surfaces.

12. The antenna of claim 1, further comprising a standoff mounted to said substrate.

13. The antenna of claim 3, wherein said folded radiating element further comprises a mounting flange extending away from said first lengthwise edge of said first component, wherein said mounting flange is substantially perpendicular to said first component.

14. The antenna of claim 13, wherein said mounting flange extends in a direction opposite to said second component.

15. The antenna of claim 13, wherein said mounting flange includes at least one aperture adapted to receive a fastening device such that said folded radiating element is removably attached to said substrate.

16. The antenna of claim 4, wherein said folded radiating element further comprises a mounting flange attached to said first component at said first lengthwise edge, said mounting flange in electrical contact with said ground plane.

17. The antenna of claim 5, wherein said dielectric member is cylindrically shaped.

18. The antenna of claim 6, wherein said dielectric member includes a passage through its longitudinal axis extending from said first dielectric surface to said second dielectric surface, wherein said parasitic element includes an aperture through its longitudinal axis, wherein said parasitic element aperture aligns with said passage.

19. The antenna of claim 18, further comprising a pin extending through said parasitic element aperture and said dielectric member aperture, said pin has a first end including a cap, and a second end.

20. The antenna of claim 19, wherein said cap contacts said parasitic element, and wherein said second end of said pin contacts a microstrip transmission line formed on said substrate.

21. The antenna of claim 4, further comprising a microstrip transition element formed on said second substrate surface, and wherein said microstrip transition element includes a first contact adapted to engage with a first conductive lead.

22. The antenna of claim 21, wherein said microstrip transition element further includes a second contact adapted to engage with a second conductive lead.

23. The antenna of claim 1, wherein said resonant cavity has a volume between 0.5 and 1.0 cubic inches.

24. The antenna of claim 1, wherein said antenna is mounted within an enclosure.

25. A transceiver comprising:
an enclosure;
transceiver circuitry; and
an antenna, said antenna comprising
a substantially planar substrate; and
a folded radiating element, wherein said folded radiating element is mounted to said substrate, said substrate and said folded radiating element defining a resonant cavity.

26. The transceiver of claim 25, wherein said antenna further comprises a dielectric member positioned within said resonant cavity and a parasitic element attached to said dielectric member.

27. The transceiver of claim 25, wherein said resonant cavity produces a wide beamwidth, polarization diverse, and substantially hemispherical radiation pattern.

28. The transceiver of claim 27, wherein said radiation pattern has a maximum gain of 6 dB.

29. The transceiver of claim 25, wherein said enclosure is formed to mount to a flat surface.

30. The transceiver of claim 25, wherein said substrate has a first substrate surface and a second substrate surface, said antenna further comprises a ground plane attached to said first substrate surface, said second substrate surface includes a microstrip transition element, and said microstrip transition element includes a first and a second contact adapted to engage with a first and a second conductive lead.

31. The transceiver of claim 30, wherein said first conductive lead is an outer jacket of a coaxial cable and said second conductive lead is a center conductor of said coaxial cable.

32. A folded radiating element attached to a substantially planar substrate, said folded radiating element comprising:
a first component oriented at an angle to said substrate; and
a second component oriented substantially parallel to the plane of said substrate;
wherein said first component is spaced a distance from said substrate, said substrate and said folded radiating element defining a resonant cavity.

33. The folded radiating element of claim 32, wherein said resonant cavity produces a wide beamwidth, polarization diverse, and substantially hemispherical radiation pattern.

34. The folded radiating element of claim 32, wherein said substrate has a first substrate surface a nd a second substrate surface, said first substrate surface includes a metalized ground plane coating.
